(19) United States
(12) Patent Application Publication
(10) Pub. No.: US 2011/0012997 A1
(43) Pub. Date: Jan. 20, 2011

(54) COMPOUND-EYE IMAGING APPARATUS

(75) Inventor: Takehiro KOGUCHI, Kurokawa-gun (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM CORPORATION, Tokyo (JP)

(21) Appl. No.: 12/835,599

(22) Filed: Jul. 13, 2010

(30) Foreign Application Priority Data
Jul. 17, 2009 (JP) JP2009-169332

(51) Int. Cl. H04N 13/02

(52) U.S. Cl. 348/47; 348/E13.074

(57) ABSTRACT

A compound-eye imaging apparatus, comprising:
a plurality of image pickup devices that are provided in positions along a left-to-right direction of an apparatus main body and image a plurality of parallax images having parallax between the plurality of parallax images, and that have a taking lens that does not protrude from a front face of the apparatus main body, respectively;
a release button provided on the apparatus main body;
a photometric device that measures a luminance of a subject based on an image signal acquired through an image pickup device that has a taking lens that is furthest from the release button; and
an exposure control device that controls an exposure of the plurality of image pickup devices, respectively, based on a luminance of the subject that is measured by the photometric device.

### BACKGROUND OF THE INVENTION

1. Field of the Invention

The present invention relates to a compound-eye imaging apparatus, and more particularly to a compound-eye imaging apparatus that images a plurality of parallax images having parallax therebetween.

2. Description of the Related Art

Among compound-eye imaging apparatuses that have a function for imaging a stereoscopic three-dimensional image comprising parallax images that have parallax therebetween, an apparatus has been proposed that uses a taking lens (hereunder, referred to as “refraction lens”) of a refractive optical system that uses a prism in order to decrease the size of the apparatus main body (see Japanese Patent Application Laid-Open No. 2009-48181).

A compound-eye imaging apparatus has also been proposed that simultaneously drives two focus lenses, calculates an evaluation value (AF evaluation value) that shows the contrast of an image for each predetermined feeding amount, and sets one focus lens at a position of another focus lens that first detected a maximum value of an AF evaluation value first (see Japanese Patent Application Laid-Open No. 2006-162990). For example, the apparatus is configured so that an AF operation can be completed efficiently in a short time by one focus lens performing an AF search from a near point to an infinite point, and the other focus lens performing an AF search from an infinite point to a near point.

Although the size of the compound-eye imaging apparatus described in Japanese Patent Application Laid-Open No. 2009-48181 is reduced by using refraction lenses, the left and right refraction lenses are arranged at the left and right ends of the apparatus main body to increase the stereoscopic effect and the presence (to lengthen the base line length).

Consequently, there is the problem that when the user grasps a grip portion (the end on the release button side) of the apparatus main body, a finger of the hand that grasps the grip portion is liable to rest on the refraction lens on the release button side.

If a finger rests on one of the left and right lenses, there is the problem that a significant difference arises between the light amounts incident on the left and right lenses, and there is a significant change between the luminance of the image for the left eye and the image for the right eye. Similarly, there is the problem that the focus and white balance correction differs between the image for the left eye and the image for the right eye, and a favorable three-dimensional image can not be obtained.

The compound-eye imaging apparatus disclosed in Japanese Patent Application Laid-Open No. 2006-162990 uses a collapsible lens barrel (see FIGS. 1A to 1D and paragraph [0016] in Japanese Patent Application Laid-Open No. 2006-162990). Hence, although a problem does not arise regarding a finger resting on a lens when imaging, the apparatus can not be made thinner and smaller. Further, since the compound-eye imaging apparatus disclosed in Japanese Patent Application Laid-Open No. 2006-162990 is configured so as to align the position of one focus lens with a focus position of the other focus lens that is focused first, it is not possible to immobilize an image pickup portion that serves as a reference.

Although according to the conventional digital cameras, a live view image (through image) is displayed on a liquid crystal monitor on the back surface of the camera before actually taking an image in order to check the composition of the subject, there is the problem that, compared to a two-dimensional (2D) through image, in the case of a three-dimensional through image it is hard to check whether a finger is resting on a lens. This is because, if a finger is resting on one of the lenses but not on another lens, an image obtained by the lens that has the finger resting thereon and an image obtained by a lens that does not have a finger resting thereon are superimposed and displayed.

### SUMMARY OF THE INVENTION

The present invention has been made in view of the foregoing circumstances, and an object of the invention is to provide a compound-eye imaging apparatus that can capture a favorable three-dimensional image regardless of whether or not a finger is resting on a lens.

A compound-eye imaging apparatus according to a first aspect of the present invention that achieves the above object includes: a plurality of image pickup devices that are provided in positions along a left-to-right direction of an apparatus main body and image a plurality of parallax images having parallax between the plurality of parallax images, and that have a taking lens that does not protrude (or protrudes by a small amount) from a front face of the apparatus main body, respectively; a release button provided on the apparatus main body; a photometric device that measures a luminance of a subject based on an image signal acquired through an image pickup device that has a taking lens that is furthest from the release button; and an exposure control device that controls an exposure of the plurality of image pickup devices, respectively, based on a luminance of the subject that is measured by the photometric device.

Among the plurality of image pickup devices, an image pickup device that has a taking lens that is furthest from the release button is adopted as a reference image pickup device, and the photometric device is configured to measure the luminance of a subject based on an image signal acquired through the reference image pickup device. Since the reference image pickup device has a taking lens that is furthest from the release button, a finger of the hand that is operating the release button does not rest on the taking lens. Because the photometric device measures the luminance of a subject based on an image signal acquired from the image pickup device (reference image pickup device) that has a taking lens on which a finger does not rest, favorable photometry can be performed. Further, because a configuration is adopted so that exposures of a plurality of image pickup devices are respectively controlled based on the photometric result, a plurality of parallax images that are imaged by a plurality of image pickup devices can be imaged with the respectively appropriate exposure, and the luminances of a plurality of parallax images can be made to match to obtain a favorable three-dimensional image.

According to a second aspect of the present invention, in the compound-eye imaging apparatus of the first aspect, the exposure control device includes: a device that determines a photographic sensitivity, an aperture value, and an exposure time based on a luminance of a subject that is measured by the photometric device; a storage device that stores deviation amounts for photographic sensitivity, aperture, and mechanical shutter delay that show individual differences from predetermined reference values of the plurality of image pickup devices; and a device that, based on a deviation amount stored in the storage device, corrects the determined photographic sensitivity and adjusts a planned mechanical shutter closing position. The apparatus can thus absorb individual differences between a plurality of image pickup devices and perform highly accurate exposure control.

A compound-eye imaging apparatus according to a third aspect of the present invention includes: a plurality of image pickup devices that are provided in positions along a left-to-right direction of an apparatus main body and image a plurality of parallax images having parallax between the plurality of parallax images, and that have a taking lens that does not protrude from a front face of the apparatus main body, respectively; a release button provided on the apparatus main body; and a focus adjustment device that, based on an image signal acquired through an image pickup device that has a taking lens that is furthest from the release button, performs focus adjustment of the taking lens, and utilizes the focus adjustment result to perform focus adjustment of a taking lens of another image pickup device.

Among the plurality of image pickup devices, an image pickup device that has a taking lens that is furthest from the release button is adopted as a reference image pickup device, and the focus adjustment device is configured to perform focus adjustment of the taking lens based on an image signal acquired through the reference image pickup device and also perform focus adjustment of a taking lens of another image pickup device utilizing the focus adjustment result. Since the reference image pickup device has a taking lens that is furthest from the release button, a finger of a hand that is operating the release button does not rest on the taking lens. Thus, since the focus adjustment device can appropriately perform focus adjustment of the taking lens on the reference image pickup device side, and also perform focus adjustment of the taking lens of another image pickup device utilizing the focus adjustment result, focus adjustment of the other taking lens can be properly performed even if a finger rests on the other taking lens.

According to a fourth aspect of the present invention, in the compound-eye imaging apparatus of the third aspect, the focus adjustment device causes the taking lens of the image pickup device that has a taking lens furthest from the release button to perform a search operation from a near point to an infinite point or from an infinite point to a near point and moves the taking lens to a focus position at which a contrast of an image obtained from the image pickup device is maximum, and causes another taking lens to perform a search operation in which a search range of the other taking lens is limited based on the focus position of the taking lens that has undergone the focus adjustment and moves the other taking lens to a focus position at which a contrast of an image obtained from an image pickup device that has the other taking lens is maximum.

Since a search range of the other taking lens is limited based on the focus position of the taking lens that has undergone the focus adjustment, the focus position of the other taking lens can be prevented from deviating to a large degree from the focus position of the taking lens that has undergone the focus adjustment. As a result, the taking lens of the other image pickup device can be focused on the same subject as the subject on which the taking lens of the reference image pickup device is focused.

According to a fifth aspect of the present invention, in the compound-eye imaging apparatus of the fourth aspect, the focus adjustment device includes: a storage device that stores a focus deviation amount corresponding to an individual difference between a taking lens that is furthest from the release button and another taking lens; a device that calculates a center position to which an other taking lens should be moved based on the focus position of the taking lens that has undergone the focus adjustment and a focus deviation amount stored in the storage device; and a device that causes the other taking lens to perform a search operation in a range of a search margin that is centered on the calculated center position.

According to a sixth aspect of the present invention, in the compound-eye imaging apparatus of the fifth aspect, when a focus position at which a contrast of an image that is to be acquired from the other image pickup device is maximum can not be obtained, the focus adjustment device moves the other taking lens to a center position to which the other taking lens should be moved. As a result, even in a case in which a focus position of another taking lens can not be obtained for some reason, by moving the other taking lens to a position corresponding to a focus position of a taking lens has undergone focus adjustment, the possibility of also focusing the other taking lens increases.

A compound-eye imaging apparatus according to a seventh aspect the present invention includes: a plurality of image pickup devices that are provided in positions along a left-to-right direction of an apparatus main body and image a plurality of parallax images having parallax between the plurality of parallax images, and that have a taking lens that does not protrude from a front face of the apparatus main body, respectively; a release button provided on the apparatus main body; a calculation device that calculates a white balance correction value based on an image signal acquired through an image pickup device that has a taking lens that is furthest from the release button; and a white balance correction device that corrects a white balance of each parallax image acquired from the plurality of image pickup devices based on a white balance correction value calculated by the calculation device.

Among the plurality of image pickup devices, an image pickup device that has a taking lens that is furthest from the release button is adopted as a reference image pickup device. The calculation device is configured to calculate a white balance correction value based on an image signal acquired through the reference image pickup device, and the white balance correction device is configured to correct a white balance of each parallax image acquired from the plurality of image pickup devices based on the calculated white balance correction value. Since the reference image pickup device has a taking lens that is furthest from the release button, a finger of the hand that is operating the release button does not rest on the taking lens. Thus, since the calculation device can calculate an appropriate white balance correction value based on an image signal obtained from the reference image pickup device, and the white balances of a plurality of parallax images acquired from a plurality of image pickup devices can be made to match, a favorable three-dimensional image can be obtained.

According to an eighth aspect of the present invention, in the compound-eye imaging apparatus of the seventh aspect, the calculation device that calculates the white balance correction value has a storage device that stores a sensitivity ratio of a color balance between an image pickup device that has a taking lens that is furthest from the release button and another image pickup device, and calculates a white balance correction value with respect to a parallax image acquired from another image pickup device based on the calculated white balance correction value and a sensitivity ratio read out from the storage device. The apparatus can thus absorb individual differences between a plurality of image pickup devices and make the white balances thereof uniform.

According to a ninth aspect of the present invention, in the compound-eye imaging apparatus of any one of the first to eighth aspects, each of the plurality of taking lenses is a taking lens of a refractive optical system.

According to a tenth aspect of the present invention, in the compound-eye imaging apparatus of any one of the first to ninth aspects, the plurality of image pickup devices are a first image pickup device and a second image pickup device that acquire an image for a left eye and an image for a right eye, respectively; and the first image pickup device and the second image pickup device are arranged so that a center position between taking lenses on the left and right deviates more to the first image pickup device side than a center position of the apparatus main body. Thus, the configuration is such that when the apparatus main body is grasped with the right hand, it is difficult for a finger of the right hand to rest on the taking lens of the second image pickup device.

According to an eleventh aspect of the present invention, the compound-eye imaging apparatus of any one of the first to tenth aspects further includes a single lens barrier that is provided so as to be movable in an upward and downward direction relative to the apparatus main body, and that simultaneously opens and closes a front face of a plurality of taking lenses of the plurality of image pickup devices.

According to a twelfth aspect of the present invention, in the compound-eye imaging apparatus of the eleventh aspect, a width in a left-to-right direction of the lens barrier approximately matches a width in a left-to-right direction of the apparatus main body.

According to a thirteenth aspect of the present invention, in the compound-eye imaging apparatus of the eleventh or twelfth aspect, a protrusion for resting a finger on is formed along the left-to-right direction on the surface of the lens barrier. The protrusion for resting a finger on formed on the lens barrier serves as a finger rest when operating the lens barrier, and also fulfills a role of preventing fingers from resting on a plurality of lenses when imaging.

According to the present invention, an image pickup device that has a taking lens that is furthest from a release button among a plurality of image pickup devices that have a taking lens that does not protrude from a front face of the apparatus main body is adopted as a reference image pickup device. Based on an image signal acquired through the reference image pickup device, exposure control (AE control) of a plurality of image pickup devices is performed, focus adjustment (AF control) of a plurality of taking lenses is performed, and white balance correction (AWB correction) of a plurality of parallax images is performed. Thus, a favorable three-dimensional image can be imaged, regardless of whether or not a finger rests on another taking lens.

### BRIEF DESCRIPTION OF THE DRAWINGS

FIGS. 1A to 1D are views that illustrate the outer appearance of a compound-eye imaging apparatus according to the present invention;

FIG. 2 is a front view that shows a state when imaging with the compound-eye imaging apparatus illustrated in FIGS. 1A to 1D;

FIG. 3 is a block diagram that illustrates a first embodiment of a compound-eye imaging apparatus according to the present invention;

FIG. 4 is a flowchart that illustrates the first embodiment of the present invention;

FIG. 5 is a block diagram of main parts of the first embodiment of the present invention;

FIG. 6 is a program chart that is applied when performing exposure control according to the present invention;

FIG. 7 is a block diagram that illustrates a second embodiment of a compound-eye imaging apparatus according to the present invention;

FIG. 8 is a flowchart that illustrates the second embodiment of the present invention;

FIGS. 9A and 9B are views that are used for describing a focus adjustment according to the present invention;

FIG. 10 is a block diagram of main parts of the second embodiment of the present invention;

FIG. 11 is a block diagram that illustrates a third embodiment of a compound-eye imaging apparatus according to the present invention;

FIG. 12 is a flowchart that illustrates the third embodiment of the present invention; and

FIG. 13 is a block diagram of main parts of the third embodiment of the present invention.

### DETAILED DESCRIPTION OF THE PREFERRED EMBODIMENTS

Hereunder, embodiments of the compound-eye imaging apparatus according to the present invention are described with reference to the attached drawings.

### [External Appearance of Compound-Eye Imaging Apparatus]

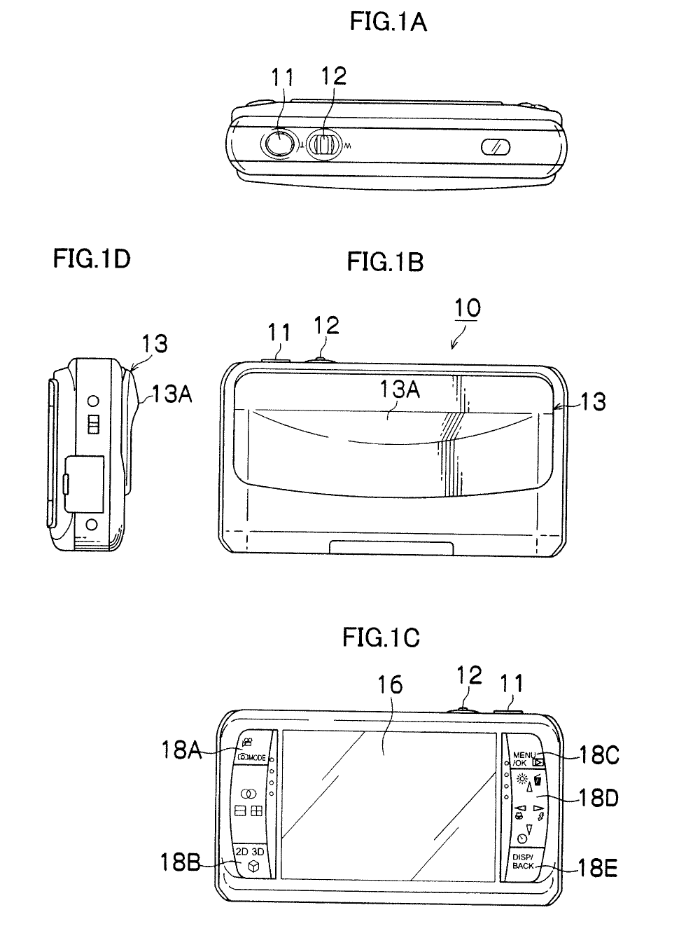

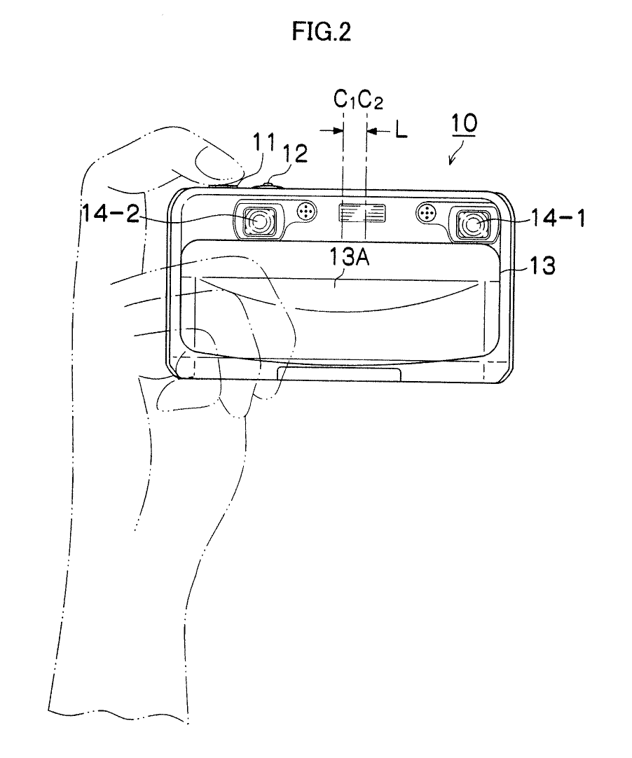

FIGS. 1A to 1D are views that illustrate the external appearance of a compound-eye imaging apparatus according to the present invention. FIGS. 1A to 1D are a top view, a front view, a back view, and a left-side surface view of the compound-eye imaging apparatus, respectively. FIG. 2 is a front view that shows a state when imaging with the compound-eye imaging apparatus shown in FIGS. 1A to 1D.

A compound-eye imaging apparatus (compound-eye camera) 10 shown in FIGS. 1A to 1D is a digital camera that is capable of recording and reproducing 2D and 3D still images and 2D and 3D moving images. As shown in FIGS. 1A to 1D, a release button 11 and a zoom button 12 are provided on the top surface of the camera main body that has a thin, rectangular solid shape.

On the front face of the camera main body, a lens barrier 13 that has a width that is approximately the same as a width in the left-to-right direction of the camera main body is provided in a condition in which the lens barrier 13 can move in an upward and downward direction relative to the camera main body. By moving the lens barrier 13 in the upward and downward direction, as shown in FIG. 2, the front faces of a pair of left and right taking lenses 14-1 and 14-2 can be opened and closed simultaneously. Refraction lenses are used as the taking lenses 14-1 and 14-2.

A protrusion for resting a finger on 13A is formed along the left-to-right direction on the front surface of the lens barrier 13. The protrusion for resting a finger on 13A serves as a finger rest when operating the lens barrier 13, and also fulfills a role of preventing a finger from resting on a lens when imaging. The configuration adopted is such that the power source of the camera can be turned on or off in response to an operation to open or close the front surface of the lenses by the lens barrier 13.

A liquid crystal monitor 16 for 3D images is provided in the center of the rear surface of the camera main body. The liquid crystal monitor 16 can display a plurality of parallax images (image for right eye and image for left eye) as directional images that have a predetermined directivity, respectively, by means of a parallax barrier. In this connection, a monitor that uses a lenticular lens or a monitor that enables the user to see an image for the right eye and an image for the left eye individually by wearing special-purpose glasses such as polarized glasses or liquid crystal shutter glasses can be applied as the liquid crystal monitor 16 for 3D images.

Various operation switches are provided on the left and right of the liquid crystal monitor 16 (FIG. 1C). An operation switch 18A is a selector switch that switches between still-image imaging and moving-image imaging. An operation switch 18B is a selector switch that switches between 2D imaging and 3D imaging. An operation switch 18C is a seesaw key that serves as both a MENU/OK button and a reproduction button. An operation switch 18D includes multifunction cross keys. An operation switch 18E is a DISP/BACK key.

The MENU/OK button is an operation switch that combines both a function as a menu button for inputting an instruction to display a menu on the screen of the liquid crystal monitor 16 and a function as an OK button that is used to confirm selected contents and the execution thereof. The reproduction button is a button that switches from an imaging mode to a reproduction mode. The cross keys are operation switches that a user uses to input an instruction for four directions, namely, up, down, left, and right. A macro button, a flash button, a self-timer button and the like are assigned to the cross keys. Further, when a menu is selected, the cross keys function as switches (cursor movement operation device) that select an item from the menu screen or instruct the selection of various kinds of setting items from each menu. The left/right keys of the cross keys also function as frame feed buttons (feed the frame in the forward direction/reverse direction) in the reproduction mode. The DISP/BACK key is used to switch the display state of the liquid crystal monitor 16, cancel instruction contents displayed on a menu screen, or to return the compound-eye imaging apparatus 10 to the immediately preceding operation state.

As shown in FIG. 2, when the center in the left-to-right direction of the camera main body is taken as C₁, and the center between the left and right taking lenses 14-1 and 14-2 is taken as C₂, C₂ deviates to the right side (right side as seen from the front side) in FIG. 2 by the amount of a length L with respect to C₁. More specifically, the taking lenses 14-1 and 14-2 are provided in a condition that the center C₂ between the lenses is shifted in a direction away from the release button 11 side with respect to the center C₁ of the camera main body. As a result, a grip portion can be secured when grasping the camera main body in the right hand and operating the release button 11.

### First Embodiment

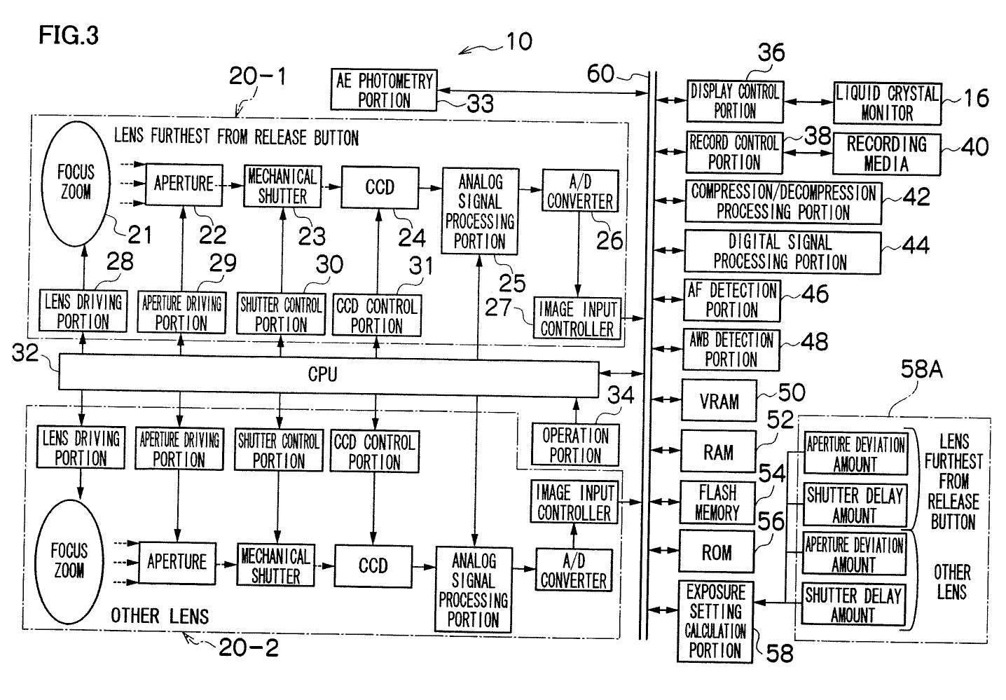

FIG. 3 is a block diagram that illustrates a first embodiment of the compound-eye imaging apparatus (compound-eye camera) 10.

As shown in FIG. 3, the compound-eye camera 10 mainly includes a plurality of image pickup portions 20-1 and 20-2, a central processing unit (CPU) 32, an AE (Automatic Exposure) photometry portion 33, an operation portion 34 including the release button 11, zoom button 12 and various operation switches, a display control portion 36, the liquid crystal monitor 16, a record control portion 38, a compression/decompression processing portion 42, a digital signal processing portion 44, an AF (Auto Focus) detection portion 46, an AWB (Automatic White Balance) detection portion 48, a VRAM 50, a RAM 52, a flash memory 54, a ROM 56, and an exposure setting calculation portion 58. In this connection, although the image pickup portions 20-1 and 20-2 image two parallax images, i.e. an image for the left eye and an image for the right eye that have parallax therebetween, three or more of the image pickup portions 20 may be provided.

The image pickup portion 20-1 that images an image for the left eye includes: a prism (not shown); an optical unit that has a refraction lens including a focus lens and zoom lens 21, an aperture 22, and a mechanical shutter 23; a solid-state imaging device (CCD) 24; an analog signal processing portion 25; an A/D converter 26; an image input controller 27; a lens driving portion 28, an aperture driving portion 29, and a shutter control portion 30 that drive the optical unit; and a CCD control portion 31 that controls the CCD 24. Since the image pickup portion 20-2 that images an image for the right eye has the same configuration as the image pickup portion 20-1 that images an image for the left eye, a description of the specific configuration thereof is omitted here.

The CPU 32 performs unified control of the operations of the entire compound-eye camera in accordance with a predetermined control program based on inputs from the operation portion 34. A control program that the CPU 32 executes and various data required for control and the like are stored in the ROM 56. Various kinds of setting information and the like relating to operation of the compound-eye camera such as user setting information is stored in the flash memory 54. The VRAM 50 is a memory that temporarily stores image data for display that is displayed on the liquid crystal monitor 16. The RAM 52 includes a computation work area of the CPU 32 and an area for temporarily storing image data.

The focus lens and zoom lens 21 included in the refraction lens are driven by the lens driving portion 28 to move forward and rearward along the optical axis. By controlling driving of the lens driving portion 28, the CPU 32 controls the position of the focus lens to perform focus adjustment so that the focal point is on the subject, and also controls the position of the zoom lens to perform zooming in accordance with a zoom instruction from the zoom button 12 in the operation portion 34.

The aperture 22, for example, comprises an iris aperture, and operates when driven by the aperture driving portion 29. The CPU 32 controls an open amount (aperture value) of the aperture 22 via the aperture driving portion 29, to thereby control the amount of light incident on the CCD 24.

The mechanical shutter 23 determines the exposure time at the CCD 24 by opening and closing the optical path, and also prevents the occurrence of smears when reading out an image signal from the CCD 24 by preventing unwanted light from being incident on the CCD 24. The CPU 32 outputs to the shutter control portion 30 a shutter close signal in synchrony with a time point at which exposure ends that corresponds to the shutter speed, to thereby control the mechanical shutter 23.

The CCD 24 is made from a two-dimensional color CCD solid-state imaging device. A large number of photodiodes are two-dimensionally arranged on a light-receiving surface of the CCD 24. Color filters are disposed in a predetermined arrangement on the photodiodes.

An optical image of a subject that is formed on the light-receiving surface of the CCD via the optical unit with the above described configuration is converted into a signal charge in accordance with an incident light amount by each photodiode. The signal charges stored in the photodiodes are read out in sequence from the CCD 24 as voltage signals (image signals) that are in accordance with the relevant signal charges based on a driving pulse applied from the CCD control portion 31 in accordance with a command from the CPU 32. The CCD 24 has an electronic shutter function, and an exposure time (shutter speed) is controlled by controlling the storage time of a charge to the photodiode. In this connection, a charge storage start time point that corresponds to a shutter speed is controlled by the electronic shutter, and a time point at which exposure ends (charge storage end time point) is controlled by closing the mechanical shutter 23. Although according to the present embodiment, the CCD 24 is used as an image pickup device, an image pickup device with a different construction, such as a CMOS sensor, can also be used.

Analog signals for R, G, and B that are read out from the CCD 24 are subjected to correlated double sampling (CDS) and amplification by the analog signal processing portion 25, and are thereafter converted into digital signals for R, G, and B by the A/D converter 26.

The image input controller 27 includes a built-in line buffer of a predetermined capacity, and after temporarily storing image signals of R, G, and B that have been subjected to A/D conversion by the A/D converter 26, stores the image signals in the RAM 52 via a bus 60.

When operating in the 3D imaging mode, the CPU 32 controls the image pickup portion 20-2 that picks up an image for the right eye in a similar manner to control of the image pickup portion 20-1 that picks up an image for the left eye.

The AE photometry portion 33 calculates a subject luminance required for AE control based on an image signal that is captured when the release button 11 is half-pressed. The exposure setting calculation portion 58 sets a shutter speed (exposure time), aperture value, and photographic sensitivity at the plurality of image pickup portions 20-1 and 20-2 based on a photometric value measured by the AE photometry portion 33.

The AF detection portion 46 calculates an absolute value of high frequency components of image signals of an AF area captured when the release button 11 is half-pressed, and outputs the calculated value (AF evaluation value) to the CPU 32. The CPU 32 performs a focus adjustment to the subject (principal subject) by moving the focus lens from a near point to an infinite point side, searching for a focus position at which an AF evaluation value detected by the AF detection portion 46 is maximum, and moving the focus lens to that focus position. The AWB detection portion 48 determines a light source type (color temperature of the field) automatically based on image signals of R, G, and B acquired at the time of actual imaging, and reads out a corresponding white balance gain from a table that stores a white balance gain (white balance correction values) for R, G, and B that are previously set according to the light source type.

The AE photometry portion 33, the AF detection portion 46, the AWB detection portion 48 and the exposure setting calculation portion 58 are described in detail later.

The digital signal processing portion 44 functions as an image processing device that includes a white balance correction circuit, a gradation conversion processing circuit (for example, a gamma correction circuit), a processing circuit that interpolates spatial deviations of color signals for R, G, and B that accompany a single-plate CCD color filter arrangement to align the positions of the color signals with each other, a contour correction circuit, and a luminance and color-difference signal generation circuit, and performs predetermined signal processing with respect to R, G, and B image signals that are stored in the RAM 52. More specifically, the digital signal processing portion 44 multiplies the R, G, and B image signals by a white balance gain detected by the AWB detection portion 48 to perform white balance correction. Thereafter, after undergoing predetermined processing such as gradation conversion processing (for example, gamma correction), the digital signal processing portion 44 converts the image signals into YC signals that include a luminance signal (Y signal) and color-difference signals (Cr and Cb signals). The YC signals that have been processed by the digital signal processing portion 44 are stored in the RAM 52.

In accordance with a command from the CPU 32 when recording to the recording media 40, the compression/decompression processing portion 42 subjects the YC signals stored in the RAM 52 to compression processing, or decompresses compression data that has been compressed and which is recorded on the recording media 40 to obtain YC signals. The record control portion 38 converts compression data that has been compressed by the compression/decompression processing portion 42 into an image file of a predetermined format (for example, a 3D still image is an MP (multi-picture) format image file) and records the image file on the recording media 40, or reads out an image file from the recording media 40.

The liquid crystal monitor 16 is used as an image display portion for displaying captured images, and is also used as a GUI (graphical user interface) when making various setting. The liquid crystal monitor 16 is also utilized as an electronic view finder for checking the angle of view in the imaging mode. When displaying a three-dimensional image on the liquid crystal monitor 16, the display control portion 36 displays an image for the left eye and an image for the right eye that are held in the VRAM 50 by displaying the pixels thereof alternately on a one-by-one basis. By means of a parallax barrier provided in the liquid crystal monitor 16, left and right images whose pixels are arranged in an alternating manner on a one-by-one basis are each individually recognized visually by the left and right eyes of a user who is observing from a predetermined distance. As a result, stereoscopic vision is enabled.

### <AE Control>

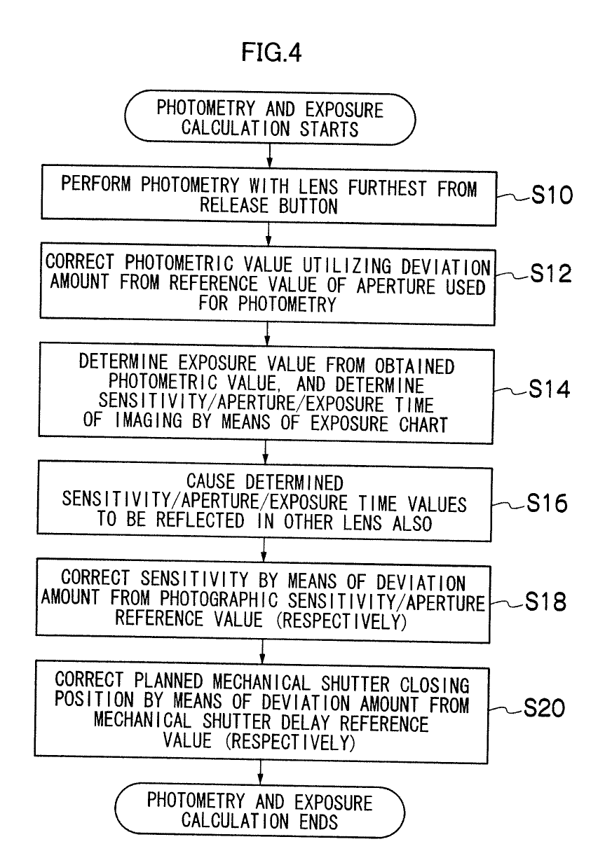

FIG. 4 is a flowchart that illustrates a first embodiment of the present invention, and relates to procedures for calculating exposure setting values in each image pickup portion.

In FIG. 4, when the release button 11 is half-pressed, the AE photometry portion 33 measures the luminance of a subject based on image signals acquired from the image pickup portion that has a lens that is furthest from the release button 11 (step S10). More specifically, the AE photometry portion 33 measures the luminance of a subject by calculating an integrated mean value of image signals acquired from an image pickup portion that has a lens that is furthest from the release button 11 (according to this embodiment, the image pickup portion 20-1 that images an image for the left eye that has a taking lens 14-1). In this connection, the photometric method is not limited to averaging metering, and various photometric methods such as center-weighted metering or spot metering can be adapted.

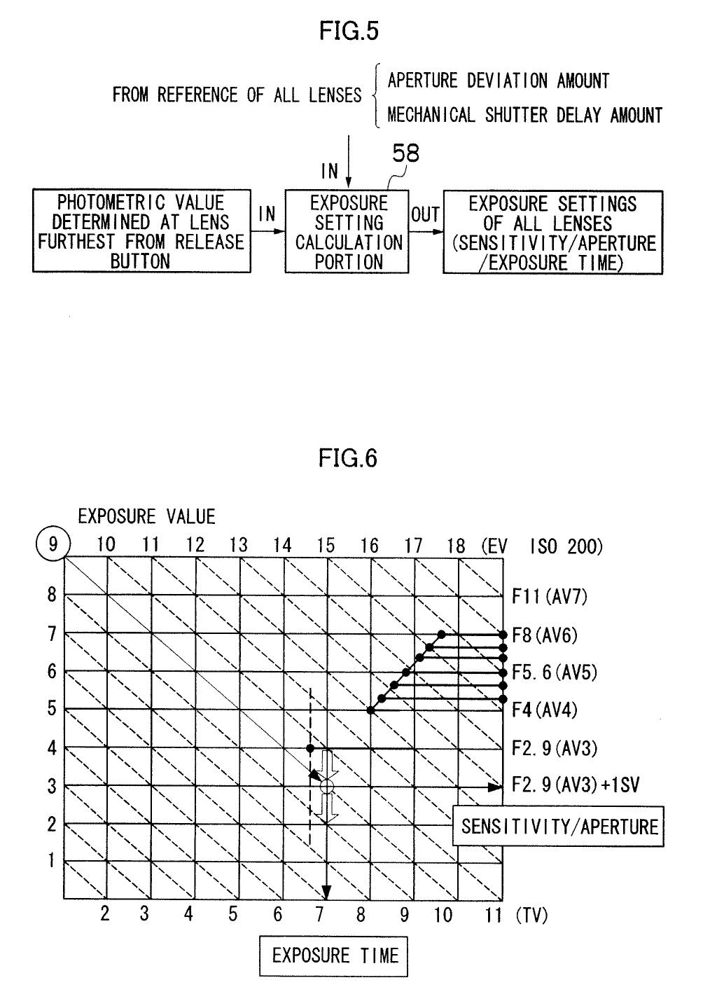

As shown in FIG. 5, a photometric value obtained by the AE photometry portion 33 is input to the exposure setting calculation portion 58. Other inputs of the exposure setting calculation portion 58 include an aperture deviation amount with respect to a reference value and a deviation amount of a mechanical shutter delay of the aperture 22 and the mechanical shutter 23 of all the image pickup portions. The exposure setting calculation portion 58 calculates an exposure setting value for all the image pickup portions based on the input photometric value and the aperture deviation amount and mechanical shutter delay deviation amount of all the image pickup portions (steps S12 to S20).

In this connection, the exposure setting calculation portion 58 is configured to enable input thereto of sensitivity/aperture deviation amounts and mechanical shutter delay deviation amounts that respectively correspond to sensitivity/aperture deviation amounts of all image pickup portions with respect to a sensitivity/aperture reference value previously stored in a storage portion 58A and mechanical shutter deviation amounts of all image pickup portions with respect to a mechanical shutter delay reference value.

Next, the exposure setting calculation portion 58 determines an exposure value (imaging EV value) based on a photometric value obtained by the above correction, and determines a photographic sensitivity, an aperture value, and an exposure time (shutter speed) by means of the exposure value and a previously set program chart (step S14).

An example of a program chart is shown in FIG. 6. For example, when the exposure value is 9, according to the program chart shown in FIG. 6, the exposure time is 1/125 (seconds) (TV7), the photographic sensitivity is ISO 400, and the aperture value is F2.9 (AV3).

Next, the exposure setting calculation portion 58 causes the exposure setting values (photographic sensitivity/aperture value/exposure time) for the image pickup portion having the lens furthest from the release button 11 that are determined as described above to be reflected as exposure setting values with respect to the image pickup portion that has the other lens (step S16).

In this case, regarding the photographic sensitivity to be set for each image pickup portion, the relevant sensitivity is corrected using a deviation amount from a sensitivity/aperture reference value of the image pickup portion in question, and the corrected sensitivity is set for the relevant image pickup portion (step S18).

Further, regarding the mechanical shutter of each image pickup portion, the planned mechanical shutter closing position is corrected using a deviation amount from a mechanical shutter delay reference value of the mechanical shutter of the relevant image pickup portion (step S20).

The exposure setting calculation portion 58 passes the exposure setting values of all the image pickup portions that have been calculated as described above to the CPU 32. The CPU 32 controls the aperture 22, the electronic shutter, the mechanical shutter 23 and the photographic sensitivity based on the set exposure setting values for each image pickup portion. Setting of the photographic sensitivity is performed by setting the amplifier gain of the analog signal processing portion 25.

According to the above described compound-eye camera configured with refraction lenses, a configuration is adopted so as to photometrically measure the luminance of a subject based on image signals acquired from an image pickup portion that has a lens furthest from the release button. Therefore, since photometry can be performed by an image pickup portion on a lens side that it is difficult for a finger to rest on (lens side on which it is 100% certain a finger will not rest when the camera is held with one hand), the photometry and exposure accuracy is enhanced. Further, by respectively correcting deviation amounts from reference values for sensitivity/aperture/mechanical shutter delay of each image pickup portion, it is possible to absorb individual differences between the respective image pickup portions and perform highly accurate exposure control, and thereby provide three-dimensional images that have high visibility.

### Second Embodiment

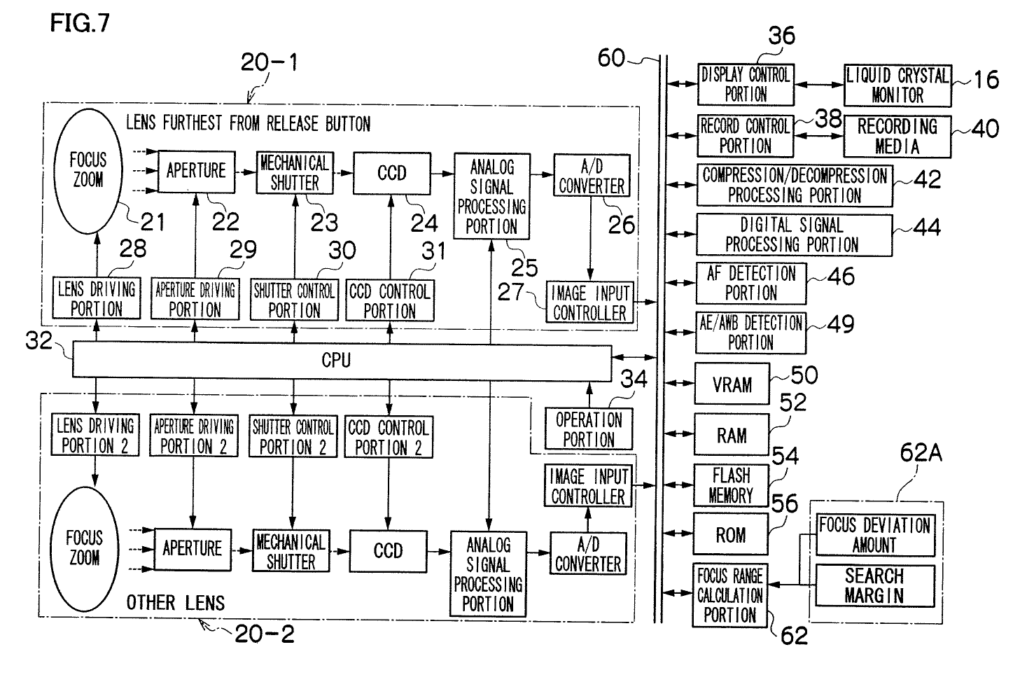

FIG. 7 is a block diagram that illustrates a second embodiment of a compound-eye camera according to the present invention. In this connection, components in FIG. 7 that are common with the first embodiment shown in FIG. 3 are designated by the same reference numerals, and a detailed description thereof is omitted below.

Relative to the compound-eye camera of the first embodiment, the compound-eye camera of the second embodiment shown in FIG. 7 is provided with an AE/AWB detection portion 49 instead of the AE photometry portion 33 and the AWB detection portion 48 shown in FIG. 3. The compound-eye camera of the second embodiment also differs from the compound-eye camera of the first embodiment in that a focus range calculation portion 62 is provided instead of the exposure setting calculation portion 58. In this connection, the AE/AWB detection portion 49 performs similar detection to the AE photometry portion 33 and the AWB detection portion 48 shown in FIG. 3.

### <AF Control>

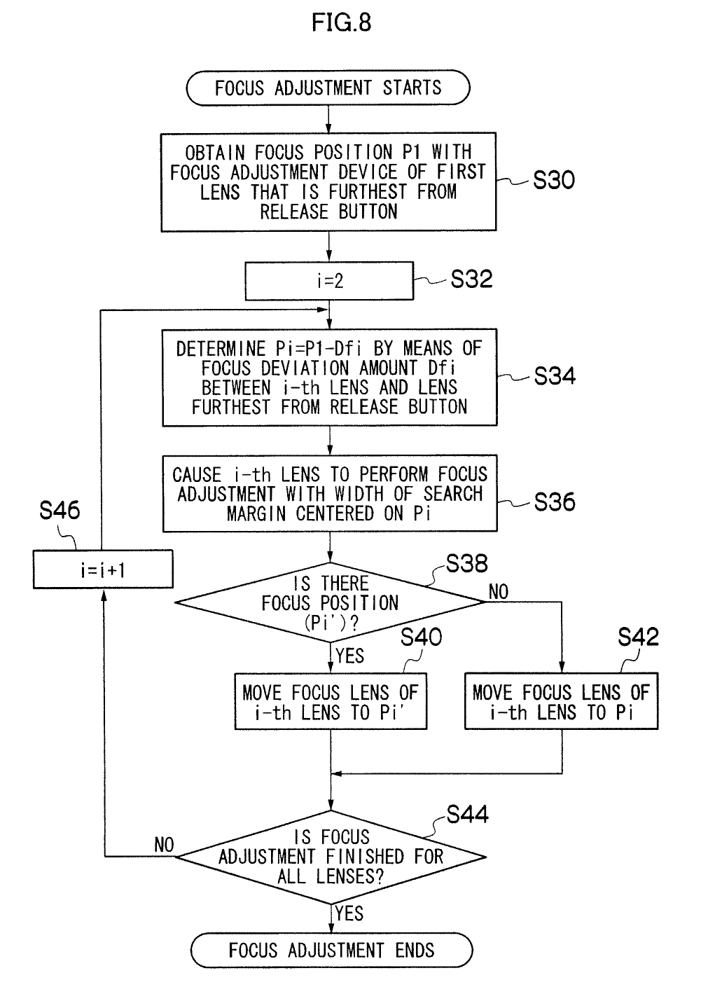

FIG. 8 is a flowchart that illustrates a second embodiment of the present invention, and relates to a focus adjustment method at each image pickup portion.

According to FIG. 8, when the release button 11 is half-pressed, the AF detection portion 46 adds absolute values of high frequency components of image signals of an AF area obtained from an image pickup portion having a lens furthest from the release button 11, and outputs the integrated value (AF evaluation value) to the CPU 32. The CPU 32 performs focus adjustment to a subject (principal subject) by moving the focus lens from a near point to an infinite point side, searching for a focus position P1 at which an AF evaluation value detected by the AF detection portion 46 is largest, and moving the focus lens to the focus position P1 (step S30).

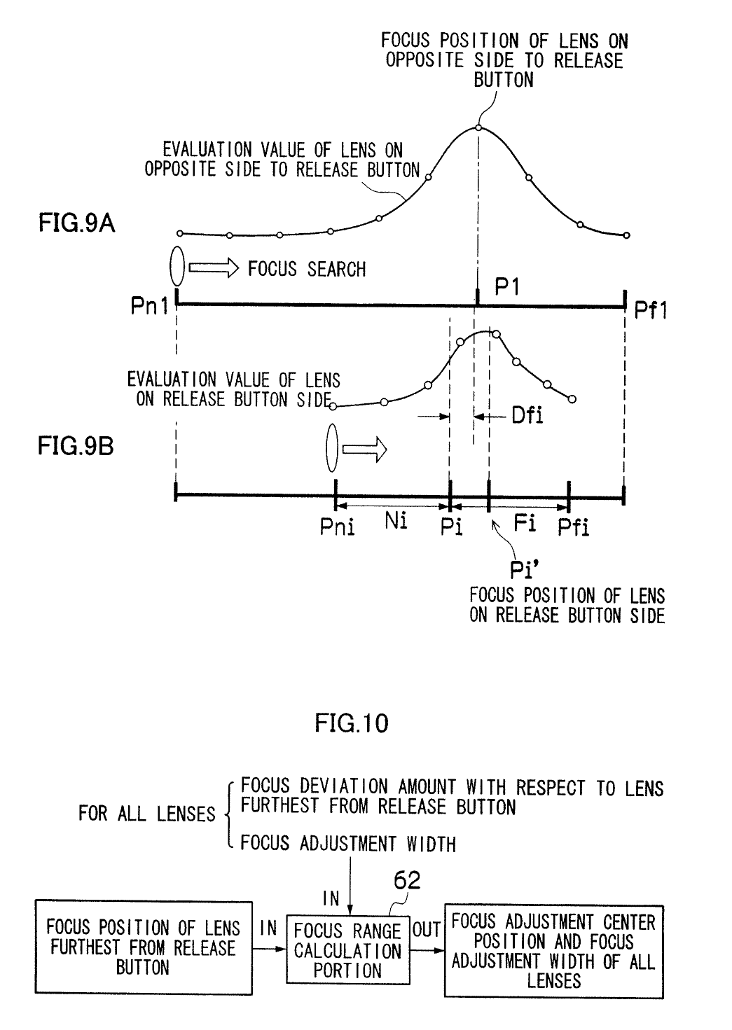

FIG. 9A is a view that illustrates the relation between a search position of a focus lens of a first lens that is furthest from the release button 11 and an AF evaluation value. The focus lens is moved to a focus position P1 at which the AF evaluation value is maximum. By obtaining the focus position P1 with a focus adjustment device of the first lens that is furthest from the release button 11, a focus position for which there is no influence of a resting finger can be obtained. In this connection, since there is a grip on the release button 11 side, there is a possibility that the user will rest a finger over the lens near the release button 11.

Subsequently, a variable i that indicates the number of image pickup portions of the compound-eye camera is set to 2 as an initial value (step S32).

As shown in FIG. 10, a focus position Pi of the first lens that is furthest from the release button 11, a focus deviation amount Dfi between the i-th lens and the first lens that is previously determined and stored in the storage portion 62A, and a focus adjustment width of a search margin (Ni, Fi) are input to the focus range calculation portion 62.

The focus range calculation portion 62 determines a center position Pi of the focus adjustment device of the i-th lens as P1-Dfi by means of the focus position P1 of the first lens and the focus deviation amount Dfi between the i-th lens and the first lens (step S34; FIG. 9B).

The focus range calculation portion 62 passes the center position Pi of the focus adjustment device of the i-th lens that is determined as described above and the focus adjustment width of the search margin stored in the storage portion 62A to the CPU 32. The CPU 32 causes the focus lens of the i-th lens to perform an AF search in a range of an Ni pulse on a near side and an Fi pulse on a far side (search margin in accordance with a temperature or posture and the like) that are centered on the center position Pi (step S36).

Based on an AF evaluation value acquired by means of the AF search of the focus lens of the i-th lens, the CPU 32 determines the existence or non-existence of a focus position Pi′ at which the AF evaluation value is a maximum (step S38). If a focus position Pi′ exists, the focus lens of the i-th lens is moved to the focus position Pi′ (step S40). If a focus position Pi′ does not exist, the focus lens of the i-th lens is moved to the calculated position Pi (step S42).

Next, the CPU 32 determines whether or not focus adjustment of all the lenses has ended (step S44). If focus adjustment of all the lenses has not ended, the CPU 32 increments the variable i by 1 (step S46), and shifts to the processing in step S34 to perform focus adjustment for the next i-th lens in the same manner as above. In this connection, although the processing returns to step S34 in accordance with the above flow line when the number of image pickup portions is three or more, if there are two image pickup portions the processing does not return to step S34.

The compound-eye camera that includes refraction lenses as described above is configured so as to perform a focus adjustment based on image signals acquired from an image pickup portion that has a lens that is furthest from the release button. Hence, focus adjustment can be performed based on image signals acquired from an image pickup portion on a lens side that it is difficult for a finger to rest on (lens side on which it is 100% certain a finger will not rest when the camera is held with one hand), a correct focus position can be obtained, and highly accurate focus adjustment can be performed. Further, by adjusting the focus of an i-th lens by taking into account a deviation amount (Dfi) between the focus lens of the i-th lens and the lens furthest from the release button that is previously determined, as well as a search margin (Ni, Fi) that depends on the temperature and posture and the like, the possibility of obtaining the correct focus positions (focus positions that are focused on the same subject) increases.

Further, even when an i-th focus position can not be obtained for some reason (for example, because a finger is resting on the lens), the possibility of focusing can be increased by moving another focus lens to a position determined based on a focus lens deviation amount that is previously determined. Thus, a three-dimensional image with high visibility can be imaged.

In this connection, although according to the above embodiment an AF search is performed from a near point towards an infinite point, a configuration may also be adopted that performs an AF search from an infinite point to a near point, for example, when imaging in a landscape mode.

### Third Embodiment

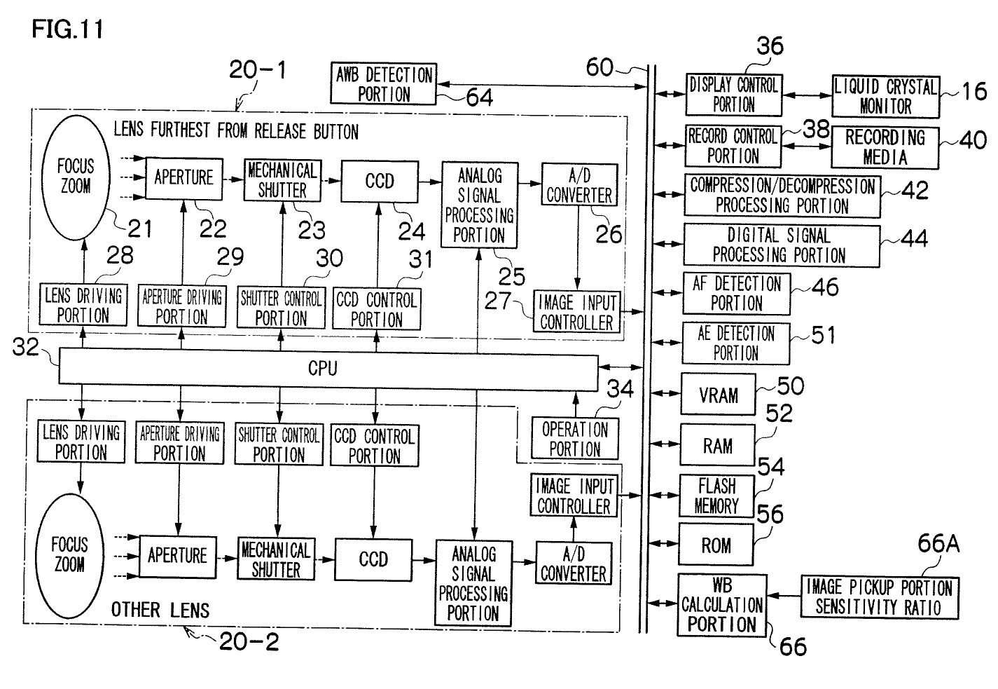

FIG. 11 is a block diagram that illustrates a third embodiment of a compound-eye camera according to the present invention. Components in FIG. 11 that are common with the first embodiment shown in FIG. 3 are designated by the same reference numerals, and a detailed description thereof is omitted below.

Relative to the compound-eye camera of the first embodiment, the compound-eye camera of the third embodiment shown in FIG. 11 provided with an AWB detection portion 64 instead of the AWB detection portion 48 shown in FIG. 3. Further, the compound-eye camera of the third embodiment is provided with an AE detection portion 51 instead of the AE photometry portion 33 shown in FIG. 3. The compound-eye camera of the third embodiment also differs from the first embodiment in that a WB calculation portion 66 is provided instead of the exposure setting calculation portion 58. In this connection, the AE detection portion 51 performs similar detection to the AE photometry portion 33 shown in FIG. 3.

### <AWB Correction>

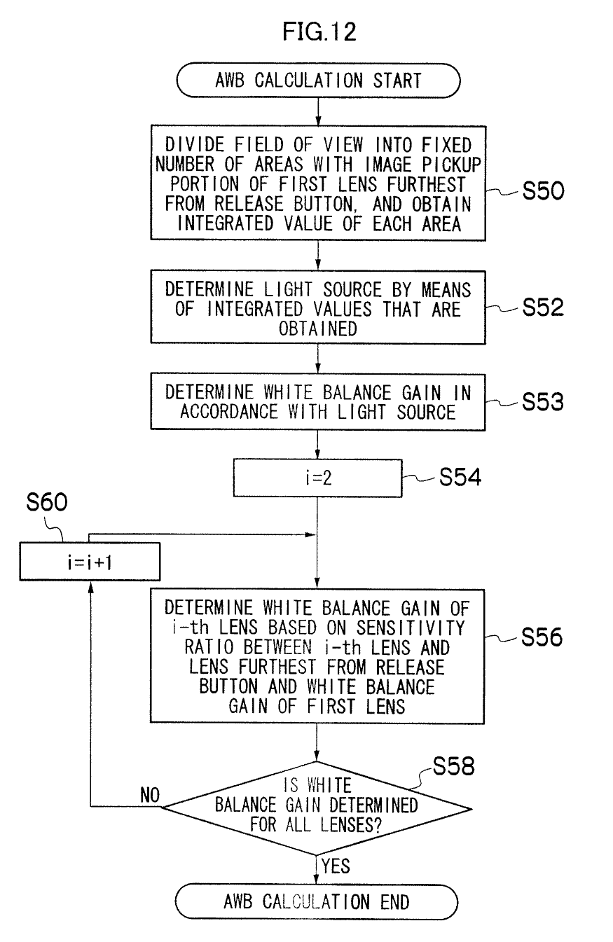

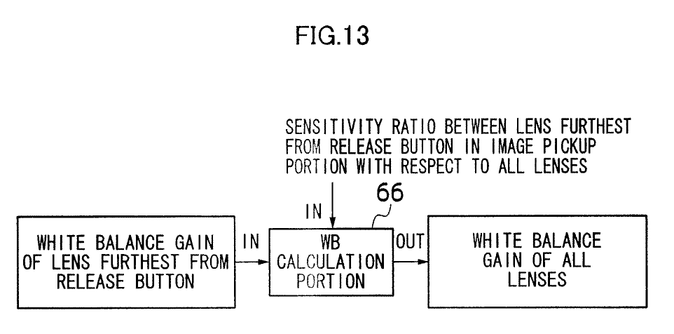

FIG. 12 is a flowchart that illustrates a third embodiment of the present invention, and relates to an AWB correction method at each image pickup portion.

In FIG. 12, among image signals of a plurality of viewpoints stored in the RAM 52 that are actually imaged when the user fully pressed the release button 11, the AWB detection portion 64 fetches image signals for one screen that are acquired from the image pickup portion that has a lens that is furthest from the release button 11, divides a screen of these image signals into a plurality of (for example, 8×8) areas, integrates the R, G, and B signals for each divided area, and calculates color information (R/G, B/G) for each of the divided areas that is represented by a ratio of the integrated values R/G/B (step S50). The AWB detection portion 64 estimates the type of light source from among various types of light sources such as shade, cloud, sunlight, fluorescent light, and tungsten light based on the distribution on a color space that takes an R/G axis and a B/G axis as coordinate axes of the color information (R/G, B/G) of each divided area that is obtained (step S52). A known method such as a method described in Japanese Patent Application Laid-Open No. 2000-224608 or Japanese Patent Application Laid-Open No. 2004-304695 can be used as the method of estimating the light source type.

After estimating the light source type, the AWB detection portion 64 determines a white balance gain (white balance correction value) that matches the estimated light source type (step S53). The white balance gain can be determined by previously preparing a table of white balance gains for performing optimal white balance correction that are organized according to each light source type, and reading out the corresponding white balance gain according to the determined light source type.

Next, a variable i that indicates the number of image pickup portions of the compound-eye camera is set to 2 as an initial value (step S54).

As shown in FIG. 13, a white balance gain of a first lens that is furthest from the release button 11 is input to the WB calculation portion 66 from the AWB detection portion 64. Further, a sensitivity ratio between the lens of the relevant image pickup portion and the lens furthest from the release button can be input with respect to all lenses to the WB calculation portion 66 from a storage portion 66A that stores sensitivity ratios of image pickup portions.

The WB calculation portion 66 calculates the white balance gain of the i-th lens based on a sensitivity ratio between the i-th lens and the first lens that is furthest from the release button and the white balance gain determined with respect to the first lens (step S56).

When the white balance gain of the first lens is taken as WBR1/WBG1/WBB1 according to the R, G, and B signals, respectively, and a sensitivity ratio between the image pickup portion of the first lens and the image pickup portion of the i-th lens is taken as GRi/GGi/GBi, the white balance gain (WBRi/WBGi/WBBi) of the i-th lens can be determined by the following formula [Equation 1].

WBRi=WBR1*GRi

WBGi=WBG1*GGi

WBBi=WBB1*GBi [Equation 1]

The WB calculation portion 66 determines whether or not calculation of the white balance gain for all lenses has ended (step S58). If calculation of the white balance gain for all lenses has not ended, the variable i is incremented by 1 (step S60), the operation moves to step S56, and performs calculation of the white balance gain for the next i-th lens in the manner described above. In this connection, although the processing returns to step S56 in accordance with the above flow line when the number of image pickup portions is three or more, if there are two image pickup portions the processing does not return to step S56.

In the compound-eye camera that includes refraction lenses as described above, since a white balance gain is calculated based on image signals acquired from an image pickup portion that has a lens that is furthest from the release button, it is possible to calculate the white balance gain based on an image signal acquired from an image pickup portion on a lens side that it is difficult for a finger to rest on (lens side on which it is 100% certain a finger will not rest when the camera is held with one hand). Hence, a correct white balance gain can be obtained and correct white balance correction can be performed. Further, by calculating the white balance gain of another lens based on the white balance gain of the lens that is furthest from the release button by using a sensitivity ratio between the image pickup portion that has the lens that is furthest from the release button and the image pickup portion that has the other lens that is previously determined, it is possible to absorb individual differences between the image pickup portions that have the respective lenses, and make the white balances uniform. As a result, a three-dimensional image with high visibility is obtained.

### [Other]

The present invention is not limited to the first to third embodiments as described above, and the embodiments may be appropriately combined.

Further, a taking lens to be applied to the present invention is not limited to a refraction lens, and may be any kind of lens as long as the lens does not protrude from the front face of the camera.

The present invention is not limited to the above described embodiments, and various variations and modifications are possible without departing from the spirit and scope of the present invention.

What is claimed is:

1. A compound-eye imaging apparatus, comprising:
a plurality of image pickup devices that are provided in positions along a left-to-right direction of an apparatus main body and image a plurality of parallax images having parallax between the plurality of parallax images, and that have a taking lens that does not protrude from a front face of the apparatus main body, respectively;
a release button provided on the apparatus main body;
a photometric device that measures a luminance of a subject based on an image signal acquired through an image pickup device that has a taking lens that is furthest from the release button; and
an exposure control device that controls an exposure of the plurality of image pickup devices, respectively, based on a luminance of the subject that is measured by the photometric device.

2. The compound-eye imaging apparatus according to claim 1, the exposure control device comprising:
a device that determines a photographic sensitivity, an aperture value, and an exposure time based on a luminance of a subject that is measured by the photometric device;
a storage device that stores deviation amounts for photographic sensitivity, aperture, and mechanical shutter delay that show individual differences from predetermined reference values of the plurality of image pickup devices; and
a device that, based on a deviation amount stored in the storage device, corrects the determined photographic sensitivity and adjusts a planned mechanical shutter closing position.

3. A compound-eye imaging apparatus, comprising:
a plurality of image pickup devices that are provided in positions along a left-to-right direction of an apparatus main body and image a plurality of parallax images having parallax between the plurality of parallax images, and that have a taking lens that does not protrude from a front face of the apparatus main body, respectively;
a release button provided on the apparatus main body; and
a focus adjustment device that, based on an image signal acquired through an image pickup device that has a taking lens that is furthest from the release button, performs focus adjustment of the taking lens, and utilizes the focus adjustment result to perform focus adjustment of a taking lens of another image pickup device.

4. The compound-eye imaging apparatus according to claim 3, wherein the focus adjustment device causes the taking lens of the image pickup device that has a taking lens furthest from the release button to perform a search operation from a near point to an infinite point or from an infinite point to a near point and moves the taking lens to a focus position at which a contrast of an image acquired from the image pickup device is maximum, and causes another taking lens to perform a search operation in which a search range of the other taking lens is limited based on the focus position of the taking lens that has undergone the focus adjustment and moves the other taking lens to a focus position at which a contrast of an image acquired from an image pickup device that has the other taking lens is maximum.

5. The compound-eye imaging apparatus according to claim 4, the focus adjustment device comprising:
a storage device that stores a focus deviation amount corresponding to an individual difference between a taking lens that is furthest from the release button and another taking lens;
a device that calculates a center position to which an other taking lens should be moved based on the focus position of the taking lens that has undergone the focus adjustment and a focus deviation amount stored in the storage device; and
a device that causes the other taking lens to perform a search operation in a range of a search margin that is centered on the calculated center position.

6. The compound-eye imaging apparatus according to claim 5, wherein when a focus position at which a contrast of an image that is to be acquired from the other image pickup device is maximum can not be obtained, the focus adjustment device moves the other taking lens to a center position to which the other taking lens should be moved.

7. A compound-eye imaging apparatus, comprising:
a plurality of image pickup devices that are provided in positions along a left-to-right direction of an apparatus main body and image a plurality of parallax images having parallax between the plurality of parallax images, and that have a taking lens that does not protrude from a front face of the apparatus main body, respectively;
a release button provided on the apparatus main body;
a calculation device that calculates a white balance correction value based on an image signal acquired through an image pickup device that has a taking lens that is furthest from the release button; and
a white balance correction device that corrects a white balance of each parallax image acquired from the plurality of image pickup devices based on a white balance correction value calculated by the calculation device.

8. The compound-eye imaging apparatus according to claim 7, wherein the calculation device that calculates the white balance correction value has a storage device that stores a sensitivity ratio of a color balance between an image pickup device that has a taking lens that is furthest from the release button and another image pickup device, and calculates a white balance correction value with respect to a parallax image acquired from another image pickup device based on the calculated white balance correction value and a sensitivity ratio read out from the storage device.

9. The compound-eye imaging apparatus according to claim 1, wherein each of the plurality of taking lenses is a taking lens of a refractive optical system.

10. The compound-eye imaging apparatus according to claim 3, wherein each of the plurality of taking lenses is a taking lens of a refractive optical system.

11. The compound-eye imaging apparatus according to claim 7, wherein each of the plurality of taking lenses is a taking lens of a refractive optical system.

12. The compound-eye imaging apparatus according to claim 1, wherein:
the plurality of image pickup devices are a first image pickup device and a second image pickup device that acquire an image for a left eye and an image for a right eye, respectively; and
the first image pickup device and the second image pickup device are arranged so that a center position between taking lenses on the left and right deviates more to the first image pickup device side than a center position of the apparatus main body.

13. The compound-eye imaging apparatus according to claim 3, wherein:
the plurality of image pickup devices are a first image pickup device and a second image pickup device that acquire an image for a left eye and an image for a right eye, respectively; and
the first image pickup device and the second image pickup device are arranged so that a center position between taking lenses on the left and right deviates more to the first image pickup device side than a center position of the apparatus main body.

14. The compound-eye imaging apparatus according to claim 7, wherein:
the plurality of image pickup devices are a first image pickup device and a second image pickup device that acquire an image for a left eye and an image for a right eye, respectively; and
the first image pickup device and the second image pickup device are arranged so that a center position between taking lenses on the left and right deviates more to the first image pickup device side than a center position of the apparatus main body.

15. The compound-eye imaging apparatus according to claim 1, further comprising a single lens barrier that is provided so as to be movable in an upward and downward direction relative to the apparatus main body, and that simultaneously opens and closes a front face of a plurality of taking lenses of the plurality of image pickup devices.

16. The compound-eye imaging apparatus according to claim 3, further comprising a single lens barrier that is provided so as to be movable in an upward and downward direction relative to the apparatus main body, and that simultaneously opens and closes a front face of a plurality of taking lenses of the plurality of image pickup devices.

17. The compound-eye imaging apparatus according to claim 7, further comprising a single lens barrier that is provided so as to be movable in an upward and downward direction relative to the apparatus main body, and that simultaneously opens and closes a front face of a plurality of taking lenses of the plurality of image pickup devices.

18. The compound-eye imaging apparatus according to claim 15, wherein a width in a left-to-right direction of the lens barrier approximately matches a width in a left-to-right direction of the apparatus main body.

19. The compound-eye imaging apparatus according to claim 16, wherein a width in a left-to-right direction of the lens barrier approximately matches a width in a left-to-right direction of the apparatus main body.

20. The compound-eye imaging apparatus according to claim 17, wherein a width in a left-to-right direction of the lens barrier approximately matches a width in a left-to-right direction of the apparatus main body.

21. The compound-eye imaging apparatus according to claim 15, wherein a protrusion for resting a finger on is formed along the left-to-right direction on the surface of the lens barrier.

22. The compound-eye imaging apparatus according to claim 16, wherein a protrusion for resting a finger on is formed along the left-to-right direction on the surface of the lens barrier.

23. The compound-eye imaging apparatus according to claim 17, wherein a protrusion for resting a finger on is formed along the left-to-right direction on the surface of the lens barrier.
